(19) United States
(12) Patent Application Publication
(10) Pub. No.: US 2024/0332804 A1
(43) Pub. Date: Oct. 3, 2024

(54) ANTENNA SYSTEM

(71) Applicant: IDNEO TECHNOLOGIES, S.A.U., Barcelona (ES)

(72) Inventors: EVGENII FILATOV, Barcelona (ES); MARCO ANTONIO VÉLEZ SANDOVAL, Barcelona (ES); JOSÉ JAVIER VICENTE VICENTE, Barcelona (ES); JOAN GEMIO VALERO, Barcelona (ES); CRISTIAN TORAL MARTÍN, Barcelona (ES); LAURA TANTINYA CUNÍ, Barcelona (ES)

(21) Appl. No.: 18/618,521

(22) Filed: Mar. 27, 2024

(30) Foreign Application Priority Data
Mar. 28, 2023 (EP) 23382291.5

(51) Int. Cl. H01Q 9/04; H01Q 15/24; H01Q 21/06

(52) U.S. Cl. CPC H01Q 9/0421; H01Q 15/24; H01Q 21/065

(57) ABSTRACT

There is provided an antenna system comprising one or more sets of radiating IFA elements each set of IFA elements configured to operate in a bandwidth BW. The disclosure provides an antenna system which achieves good performance in a limited space.

### CROSS-REFERENCE TO RELATED APPLICATIONS

This application claims the benefit of European Application Serial No. 23382291.5 filed Mar. 28, 2023, the disclosure of which is incorporated herein by reference in its entirety.

### BACKGROUND

The present disclosure relates to an antenna system.

Antenna systems require, in some examples, limited dimensions such that the antenna system may be integrated in a particular system. Besides, some antennas used for positioning require accurate positioning and require being configured to operate in different regions using different GNSS systems. In some examples, autonomous driving is becoming a trend in automotive sector. The performance of an autonomous vehicle relies, in part, on the antenna system that the vehicle is equipped with. In examples, the antenna dimensions may be one of the most critical aspects to consider. In some examples, an antenna dimensions are designed as small as possible to ensure easy integration of the antenna in a limited available space in the vehicle, preserving good antenna efficiency, gain and good axial ratio. In some cases, there is a demand on multiband and multi-constellation GNSS antennas. Some GNSS systems require to operate for GPS in the USA, Galileo in the European Union, BeiDou in China, GLONASS in Russia, NAVIC in India, and QZSS in Japan.

There is a need for an antenna system which achieves good performance in a limited space.

### SUMMARY

The present disclosure provides examples of systems that at least partially resolve some of the aforementioned disadvantages.

In a first exemplary embodiment, there is provided an antenna system including a first set of radiating elements configured to operate at least in a first frequency bandwidth and a ground plane. The first set of radiating elements includes a first number N of at least 3 inverted-F radiating elements, first N IFA element. Each of the first N IFA elements include a first arm having at least a first section extending, at a first extension point, into a second section. The first section of the first arm includes a connection to a respective feeding point. A second arm includes at least a first section extending, at a first GND point, into a second section. The second section of the second arm is connected to the first extension point. The first sections of all of the N second arms form a first common GND connection between the first GND point and the GND plane. A length of the first common GND connection defines a first height, and the first GND point is common to the N second sections of the second arms. The first N IFA elements are distributed around the first GND point on a plane A. The plane A is parallel to the GND plane and is distanced from the GND plane the first height, such that the first GND point is positioned in the plane A. Any of the second sections of the first arm or second arms of the first N IFA elements form respective angles between 0° and 30°, where 0° and 30° are included, with respect to the plane A.

The antenna system includes a first set of radiating elements and a GND plane. The first set of radiating elements includes a first number N of at least 3 inverted-F radiating elements, first set of IFA elements. The first set may include 3 IFA radiating elements, or 4, or 6 or even 8 radiating elements. Each IFA radiating element is an Inverted-F Antenna, wherein an IFA antenna is a type of antenna used in wireless communication. The IFA antenna includes a monopole antenna and is grounded at one end. The IFA antenna is fed from a feeding point. Each of the first set of IFA elements of the disclosure include a first arm having at least a first section extending, at a first extension point, into a second section. Each first section of each first arm of the first set of IFA elements includes a connection to its corresponding feeding point. The corresponding feeding points are different from each other in the first set of IFA elements. In other words, if for example the antenna system includes a first set of IFA elements with three IFA elements, a first first section of a first arm includes a connection to a first feeding point, a second first section of a different first arm includes a connection to a second feeding point and a third first section of a further different first arm includes a connection to a third feeding point. The first, second and third feeding points are different from each other.

All first set of IFA elements further include a second arm. The second arm includes a first section extending, at a first GND point, into a second section, the second section of the second arm connected to the first extension point. The first sections of all the N second arms form a single and shared first common GND connection between the first GND point, which is common to or shared by the N second arms, and the GND plane. The length of the first common GND connection defines a first height h1. The first GND point may be an electrical point having the shape of a metallic ring to which all the second sections are connected, or soldered, for example. The length of the first common GND connection is referred to as first height, h1. The first height h1 may range from λ/20 to λ/10.

When viewed from above, the N radiating elements or first IFA elements are distributed with respect to each other. The distribution may include an angular distribution and may further include a uniform angular distribution. For example, the angular distribution may be 360°/N. In other words, the first set of IFA elements may be angularly uniformly distributed around the first GND point on a plane A, wherein the plane A is parallel to the GND plane and distanced from the GND plane the first height, h1, and the first GND point is comprised in the plane A. The antenna system is such that any of the second sections of the first or second arms of the first N IFA elements form respective angles between 0° and 30°, where 0° and 30° are included, with respect to the plane A.

As seen, the first IFA elements share the common GND connection or shorting connection to the GND plane. The antenna system of the present disclosure includes, therefore, N IFA elements in which the shorting connection to GND is shared.

In some embodiments, the antenna system of the present disclosure further includes a second set of radiating elements configured to operate at least in a second frequency bandwidth, BW2. The second set of radiating elements include a second number N of at least 3 inverted-F radiating elements, second N IFA elements. Each of the second set of N IFA elements include a third arm having at least a first section extending, at a second extension point, into a second section. The first section of the third arm includes a connection to a corresponding feeding point. A fourth arm includes at least a first section extending, at a second GND point, into a second section. The second section of the fourth arm is connected to the second extension point. The first sections of all the N fourth arms form a second common GND connection between the second GND point and the GND plane. A length of the second common GND connection defines a second height, and the second GND point is common to the N second sections of the fourth arms.

The second N IFA elements are distributed around the second GND point on a plane B. The plane B is parallel to the GND plane and is distanced from the GND plane the second height, such that the second GND point (27) is included in the plane B.

Any of the second sections of the third arms or of the fourth arms of the second N IFA elements form respective angles between 0° and 30°, where 0° and 30° are included, with respect to the plane B. When viewed from above, the first set of radiating elements and the second set of radiating elements, overlap less than a 10% of an angular distribution with respect to each other.

In such embodiments, the second number N of the second set of IFA elements, may be the same as the first number N of first set of IFA elements. For example, the first set of IFA elements may comprise 3, or 4 IFA elements and the second set of IFA elements may comprise 3 or 4 IFA elements respectively. Each of the second N IFA elements include a third arm. The third arm includes a first section extending, at a second extension point, into a second section. The first section includes a connection to its corresponding feeding point. The corresponding feeding points are different from each other in the second set of IFA elements. For example, if there are three third arms in the second set of IFA elements, a first section of a first third arm includes a connection to a feeding point different to a feeding point connected to a first section of a second third arm. The first and second feeding points are different from a third feeding point connected to a first section of a third third arm.

A corresponding feeding point or connection to a corresponding feeding point may be the same as any feeding point or connection to a corresponding feeding point of one of the first sections of the first arms of the first set of IFA elements. For example, the feeding point or connection to a corresponding feeding point of a third arm in the second set of IFA elements may be the same as the feeding point or connection to a corresponding feeding point of a first arm in the first set of IFA elements as will be illustrated by the examples below. All IFA elements in the second set of IFA elements further comprise a fourth arm. The fourth arm includes a first section extending, at a second GND point, into a second section, the second section of the fourth arm connected to the second extension point. The first sections of all the N fourth arms form a single and shared second common GND connection between the second GND point, which is common to or shared by the N fourth arms, and the GND plane.

The second GND point may be an electrical point along a metallic ring to which all the second section of the fourth arms are connected, or soldered, for example. The second section of the fourth arms are all connected to the GND plane, through the second common GND connection, and the second common GND connection extends into the first common GND connection, thereby completing all the IFA elements.

When viewed from above, the second set of N IFA elements are distributed around the second GND point on a plane B, wherein the plane B is parallel to the GND plane and distanced from the GND plane a second height, h2, and the second GND point is comprised in the plane B. The length of the second common GND connection is referred to as second height, h2. The second height h2 separating the plane B from the GND plane may range from λ/20 to λ/10. The second set of N IFA elements may be angularly distributed around the second GND point and may further be uniformly angularly distributed, where uniformly angularly distributed may include presenting an angular distribution or separation of 360°/N between two consecutive second IFA elements of the second set. Any of the second section of the third arms or the second section of the fourth arm of the second set of N IFA elements form respective angles between 0° and 30°, where 0° and 30° are included, with respect to the plane B.

When viewed from above, the first set of radiating elements and the second set of radiating elements, overlap less than a 10% of a distribution with respect to each other. In some embodiments, when viewed from above, all the radiating elements, including the first set of radiating elements and the second set of radiating elements, are uniformly angularly distributed with respect to each other. In other words, there is no overlap with respect to each other.

In some embodiments, the first and second sets of IFA elements or radiating elements all share a common connection to the GND plane. Radiating elements of different sets may also share their connections to the feeding points.

The antenna system may further include a third set of radiating elements, all sharing the connection to GND plane. The third set of radiating elements include arms whose GND point may be included in a third plane parallel to GND plane and distanced a third height h3 from GND plane. The antenna system may further include further sets of radiating elements, IFA elements, whose connection to GND plane extend over the common GND connection. The connections to the feeding points of one or more of the arms of the further sets of IFA elements may be common to one or more arms of different sets.

Advantageously the antenna system of the present disclosure provides a self-grounded antenna and, for example when mounted in a vehicle, an installation on top of a ground plane provided by a vehicle roof is not necessary. The antenna may be hidden inside a location covered with non-metallic material, for example inside the rear spoiler of the vehicle.

An antenna system including two or more sets of IFA elements allows for a multiband and multi-constellation antenna system which may include, for example, from 1559 MHz to 1610 MHz referred to as L1/E1 band, and/or from 1164 MHz to 1300 MHz referred to as L5/E5 and/or L2 and/or Galileo E6, bands. Miniaturization techniques may be implemented for the manufacture of an antenna system according to the present disclosure, which may provide a compact size. The disclosure provides, therefore, a multiband and multi-constellation antenna system which achieves good performance in a limited space.

In some embodiments, the antenna system further includes a printed circuit board assembly, PCBA. The PCBA includes the GND plane and the feeding points. The PCBA may include a polarizer, and the first set of N IFA elements or the first and second N IFA elements are placed on or over the PCBA and in connection to the PCBA. The polarizer may serve to increment a phase of a feeding current such that different feeding points of the same set of IFA elements are fed with the same current with a different phase for each feeding point. The polarizer may provide a circular polarization and may be clockwise or right-handed circular polarization (RHCP) in which the electric field vector rotates in a right-hand sense with respect to the direction of propagation, or counter-clockwise or left-handed circular polarization (LHCP). The PCBA with polarizer allows a directive RHCP or LHCP field at Zenith. The antenna system of the present disclosure advantageously provides a rejection of low elevation incoming signals.

In some embodiments, the PCBA includes a first side on which any of the first or second set of the IFA elements, the GND plane and the connection to the feeding points are placed, and a second side, opposite to the first side, including at least a polarizer. The second side may further include the following active electronic elements, a filter and an amplifier. With the use of active electronic elements, the second side may further include a shielding configured to surround at least the filter and the amplifier, providing a direct connection to GND plane, the shielding including a metal sheet of electrically conductive material. The shielding surrounds, in some examples, all the electronic elements mentioned above. The fabrication materials of the antenna system of the present disclosure may include metal, and metal sheets, which may reduce the overall cost of fabrication compared to other materials. In some embodiments the feeding points may be included on the first side or on the second side. The feeding points may be a continuous track through the PCB. The connection to said feeding points are on the first side, as defined above.

In some embodiments at least one of the second section of the first arms or of the third arms of the first or second set of IFA elements have an increasing width along the length of the arm, starting with a first width at the extension point and ending in a second width at an open end of the arm. The increment of between the first width and the second width may be within the range of 0 to λ/10, including 0 and λ/10. This shape is referred to as bow tie shape and may provide advantages such as increasing the operational bandwidth BW1 or BW2 of operation of the any of the radiating elements or IFA elements.

In some embodiments of the antenna system the first common GND connection includes or forms a metallic tube, or the first and second common GND connections include or form a metallic tube. The metallic tube is joint and in electrical connection to the GND plane and extends from the GND plane to the second and/or first GND points. The tube provides a structural supportive element to the sets of radiating IFA elements, and the tube acts as a common connection to GND plane. In some examples the tube is hollow, and, when the antenna system includes a PCBA, an antenna cable may be connected to the PCBA and arranged along the inside of the hollow tube for connection to, for example, a receiver or reader, that may be elements external to the antenna.

The antenna cable may serve to conduct data signals coming from an emitter, for example a satellite or an RFID tag, or any other data source, and captured by the antenna system. The cable may conduct such signals towards the receiver. In examples where the second section of the second and/or the fourth arms are connected to a metallic ring acting as the GND point, the metallic ring may be the edge of the hollow tube, wherein the hollow tube may extend from the metallic ring towards the GND plane. The PCB may include a through hole coinciding with the hollow tube so that the antenna cable may be connected to the second side of the PCBA.

In some embodiments a dimension of the GND plane is larger than the largest length of any of the first set of antennas or the second set of antennas, such that the GND plane encompasses a complete projection of the sets of antennas on the GND plane. In these embodiments, as will be illustrated in the examples below, the PCBA may act as a director or as a reflector for the antenna system. In some cases, the length of the side of the GND plane may range from λ/6 to λ/2, being λ the wavelength of the frequency of operation, or the lowest frequency in the frequency band of operation. In these cases, the second side of the PCBA faces or is closer to the zenith direction. The PCBA acts as a director and the radiating IFA elements project towards an opposite direction. In other cases, the antenna system may be installed on top of a large GND plane, for example a GND plane whose side length is more than λ/2. In these cases, the PCBA works as a reflector, wherein the radiating IFA elements project towards and the first side of the PCBA faces or is closer to the zenith direction. This may be referred to as the external ground plane solution.

In some embodiments a dimension of the GND plane is shorter than the largest length of any of the sets of antennas, such that the GND plane does not encompass a complete projection of the sets of antennas on the GND plane.

In some embodiments, either one or both of the second section of the second or of the fourth arm of the first or second set of IFA elements may have a meandered shape. For example, they may include a Hilbert element in order for the radiating IFA elements to operate at a lower frequency or at lower frequency bands without increasing the antenna dimensions.

In some embodiments, the antenna system includes a housing, the housing configured to encompass all the radiating elements and the ground plane. Advantageously the housing protects the antenna system. In such examples, at least one IFA element of the first or second set may comprise fixation elements to fix the at least one IFA element to the housing. For example, the fixation elements may include housing positioners, or holes, or a screw or positioner may be comprised to join both the IFA element and the housing together. The housing may include profiles or projections to fit the radiating IFA elements therein and prevent the antenna system from moving. The IFA elements, depending on the material they are made of or how is manufactured, may sag, or move due to different factors, modifying the antenna performance. The profiles or projections may avoid horizontal and/or vertical movements.

In some embodiments, the first arm has a first length, Le1, wherein Le1 is the sum of the lengths of at least the first section and the second section, wherein the Le1 may range from λ1/8 to λ1/4, being λ1 the wavelength of the lowest frequency in the BW1. For example, if BW1 ranges from a first frequency fa to a second frequency fb, and fa<fb, then λ1=υ/fa with υ the propagation speed of the propagating wave in the corresponding medium.

In some embodiments, the second arm has a second length, Le2, and Le2 may range from λ1/20 to λ1/2. Le2 is the sum of the lengths of the first and second sections of the second arm.

In some embodiments, the third arm has a third length, Le3, wherein Le3 may range from λ2/8 to λ2/4, being λ2 the wavelength of the lowest frequency in the BW2. Le3 is the sum of the lengths of at least the first section of the third arm and the second section of the third arm.

In some embodiments, the fourth arm has a length Le4 and Le4 may range from λ2/20 to λ2/2. Le4 is at least the sum of the length of the first and second sections of the fourth arm. In some embodiments, Le4 is the sum of the length of first section and the length of second section of the fourth arm and the length of the first section of the second arm.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples but should be determined only by a fair reading of the claims that follow.

### BRIEF DESCRIPTION OF THE DRAWINGS

Non-limiting examples of the present disclosure will be described in the following, with reference to the appended drawings, in which:

FIG. 1 schematically represents a first example of an antenna system 10, viewed from above;

FIGS. 2A-2B schematically represents the antenna system 10 of FIG. 1 on an elevation view;

FIG. 3 schematically represents a second example of an antenna system 20, viewed from above;

FIGS. 4A-4B schematically represents the antenna system 20 of FIG. 3 on an elevation view;

FIG. 5 shows a plan view of a third example of an antenna system 50 showing 4 IFA elements;

FIG. 6 shows an elevation view of a fourth antenna system 60 having two sets of radiating elements;

FIG. 7 shows a plan view of the antenna system 60 of FIG. 6;

FIG. 8 shows a fifth example of an antenna system 80 comprising a housing 81;

FIG. 9 shows a representation of the antenna axial ratio with respect to frequency;

FIG. 10 shows the RHCP gain at the zenith direction in a director configuration of the antenna system;

FIG. 11 shows a vertical cut of the radiation pattern of the antenna system for a frequency of 1.28 GHz;

FIG. 12 shows a vertical cut of the radiation pattern of the antenna system for a frequency of 1.58 GHz;

FIG. 13 shows a vertical cut of the radiation pattern of the antenna system for a frequency of 1.18 GHz;

FIG. 14 shows a perspective view of an antenna system 140 according to the disclosure.

### DETAILED DESCRIPTION

In these figures the same reference signs have been used to designate matching elements.

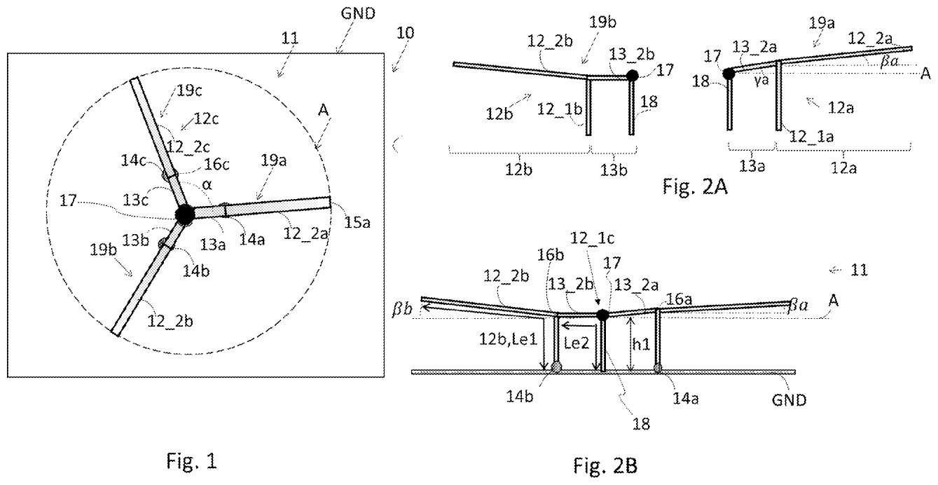

FIG. 1 shows a plan view and FIGS. 2A and 2B show an elevation view of a first example of an antenna system 10 comprising: a first set 11 of radiating elements configured to operate at least in a first frequency bandwidth, BW1; a ground plane, GND plane. The first set 11 of radiating elements comprises a 3 inverted-F radiating elements, first IFA elements 19a, 19b, 19c. FIG. 2A represents a zoomed and separated extraction of the first IFA elements 19a and 19b of FIG. 2B. The first sections 18 of the second arms 13a and 13b form a one single piece, which is the common GND connection, but are represented separated in FIG. 2A only for illustrative purposes. The common GND connection 18 may form a metallic tube. Preferably, the metallic tube is hollow, and an antenna cable may be arranged along the inside of the hollow tube. When the antenna system comprises a PCBA, the cable may be connected to the PCBA.

Each of the IFA elements of the first or second set comprises a first arm 12a, 12b, 12c, comprising at least a first section 12_1a, 12_1b,12_1c, extending, at a first extension point 16a, 16b, 16c, into a second section 12_2a, 12_2b, 12_2c; wherein the first section 12_1 comprises a connection 14a, 14b, 14c to a corresponding feeding point. The first set of IFA elements comprises a second arm 13a, 13b, 13c comprising a first section 18 extending, at a first GND point 17, into a second section 13_2a, 13_2b, 13_2c wherein the first sections of the second arms 13a, 13b, 13c are all connected to the GND plane and form a first common GND connection 18, a length of the first common GND connection 18 defining a first height, h1. The second sections of the second arms are all connected to the GND point 17. As seen in FIGS. 1, 2A and 2B the first 3 IFA elements are angularly uniformly distributed around the first GND point 17 on a plane A, wherein the plane A is parallel to the GND plane and distanced from the GND plane the first height h1, such that the first GND point 17 is comprised in the plane A. In FIG. 1 angularly uniformly distributed around the first GND point 17 comprises that the first set of IFA elements are all separated an angle α is 360/3=120°. In FIGS. 2A and 2B the second section 12_2a of the first arm 12a of the first radiating element 19a and the second section 12_2b of the first arm 12b of the second radiating element 19b form respective angles βa,βb between 0° and 30°, where 0° and 30° are included, with respect to the plane A. The second section 13_2a of the second arm 13a forms an angle γa between 0° and 30°, where 0° and 30° are included, with respect to the plane A.

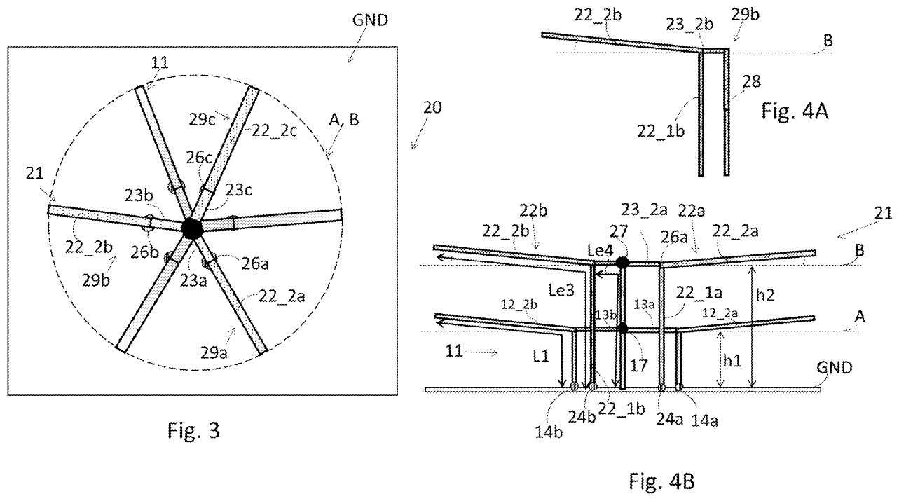

FIG. 3 shows a plan view and FIGS. 4A and 4B show elevation views of a second example of an antenna system 20. FIG. 4A represents a separated extraction of the IFA element 29b of the antenna system 20. The antenna system 20 comprises the elements of FIGS. 1, 2A and 2B, and further, a second set 21 of radiating elements configured to operate in a second frequency bandwidth, BW2, the second set 21 comprising 3 second IFA elements 29a, 29b, 29c, for this example, the same number of IFA elements than the first set; wherein each of the 3 second IFA elements 29a, 29b, 29c comprise: a third arm 22a, 22b, 22c comprising at least a first section of the third arm 22_1a, 22_1b, 22_1c, extending, at a second extension point 26a, 26b, 26c, into a second section of the third arm 22_2a, 22_2b, 22_2c; wherein the first section of the third arm 22_1a, 22_1b, 22_1c comprises a connection 24a, 24b, 24c to a corresponding feeding point; and to the corresponding second extension point 26a, 26b, 26c. Each of the 3 second IFA elements 29a, 29b, 29c further comprise a fourth arm 23a, 23b, 23c, comprising a first section 28 extending, at a second GND point 27, into a second section 23_2a, 23_2b, 23_2c, the second section of the fourth arm connected to the second extension point 26a, 26b, 26c, wherein the first sections 28 of the 3 fourth arms 23a, 23b, 23c form a second common GND connection 28 between the second GND point 27 and the GND plane. The length of the second common GND connection 28 defines a second height h2. The second GND point 27 is common to the 3 second sections 23_2a, 23_2b, 23_2c of the fourth arms 23a, 23b, 23c. The second common GND connection 28 extends into the first common GND connection 18.

The 3 second IFA elements, as seen in FIG. 3, are angularly uniformly distributed around the second GND point 27 on a plane B, wherein the plane B is parallel to the GND plane and distanced from the GND plane a second height h2, as illustrated in FIG. 4B. The second common GND point 27 is, therefore, comprised in the plane B.

Any of the second sections 22_2a, 22_2b, 22_2c, 23_2a, 23_2b, 23_2c of the third arms or of the fourth arms 23a, 23b, 23c form respective angles between 0° and 30°, where 0° and 30° are included, with respect to the plane B. In FIGS. 4A and 4B the second section of the third 22_2a and 22_2b are shown forming an angle with respect to B whereas the second section of the fourth arms 23_2a and 23_2b form an angle of 0° or form no angle with respect to the plane B.

As seen in FIG. 3, when viewed from above, the first set 11 of radiating elements and the second set 21 of radiating elements, overlap less than a 10% of a uniform angular distribution with respect to each other. In the example of FIG. 3 the sets of IFA elements overlap a 0% with respect to each other or do not overlap.

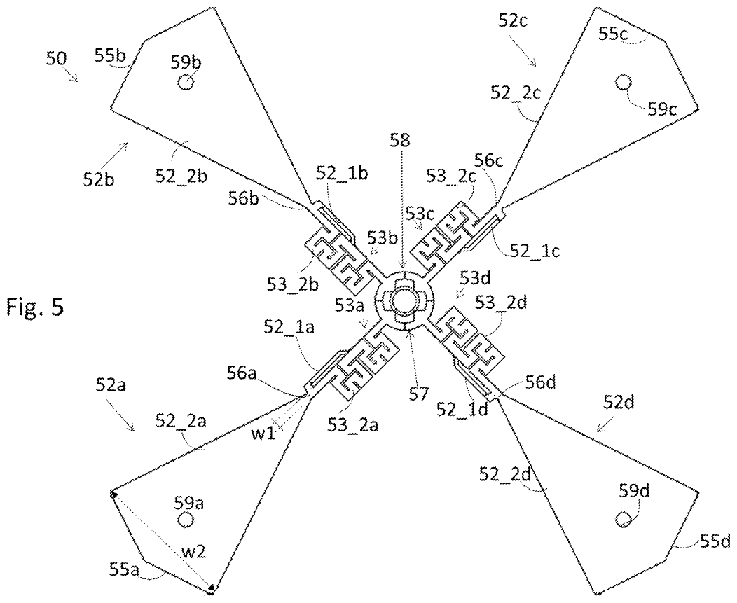

FIG. 5 shows a plan view of a third example of an antenna system 50 showing 4 IFA elements comprised in the antenna system 50. The 4 IFA elements have a bow tie shape or, in other words, the second section 52_2a, 52_2b, 52_2c, 52_2d of the first arms of the 4 IFA elements have an increasing width along the length of the first arm, starting with a first width w1 at the extension point 56a, 56b, 56c, 56d and ending in a second width w2 at an open end 55a, 55b, 55c, 55d of the first arm.

FIG. 5 shows the GND point 57 made as a metallic ring to which all the second sections 53_2a, 53_2b, 53_2c, 53_2d of the second arms are connected, or soldered. The second section of the second arms 53_2a, 53_2b, 53_2c, 53_2d are all connected to the GND plane through a common GND connection 58 which may be a hollow tube and is hidden in the plan view of FIG. 5.

As seen in FIG. 5, the 4 IFA elements are angularly uniformly distributed around the first GND point 57 when viewed from above.

In FIG. 5 the first sections 52_1a, 52_1b, 52_1c, 52_1d of the first arms 52a, 52b, 52c, 52d are shown displaced from the second arm when viewed from above. The feeding points connected to the first sections are not shown or hidden behind the second sections 53_2a, 53_2b, 53_2c, 53_2d of the second arms 53a, 53b, 53c, 53d in the FIG. 5. The second sections 53_2a, 53_2b, 53_2c, 53_2d of the second arms in the FIG. 5 have a meandered shape or Hilbert shape. FIG. 5 shows 4 housing positioners 59a, 59b, 59c, 59d to fix each of the 4 IFA element to a housing.

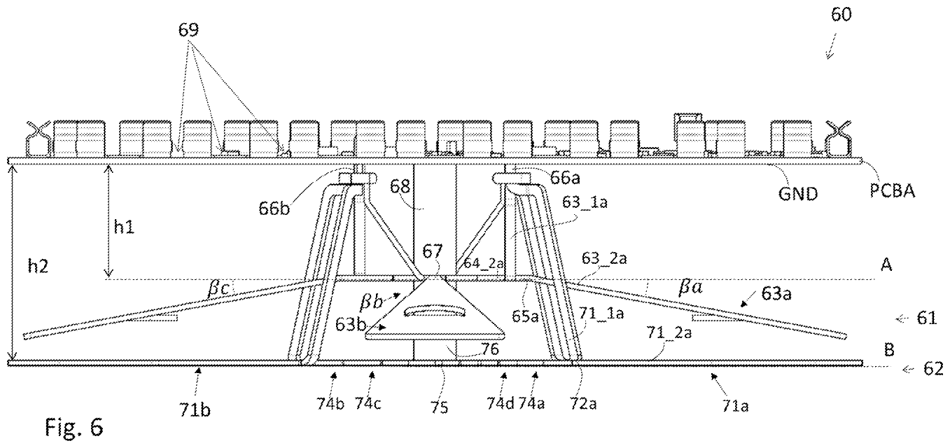

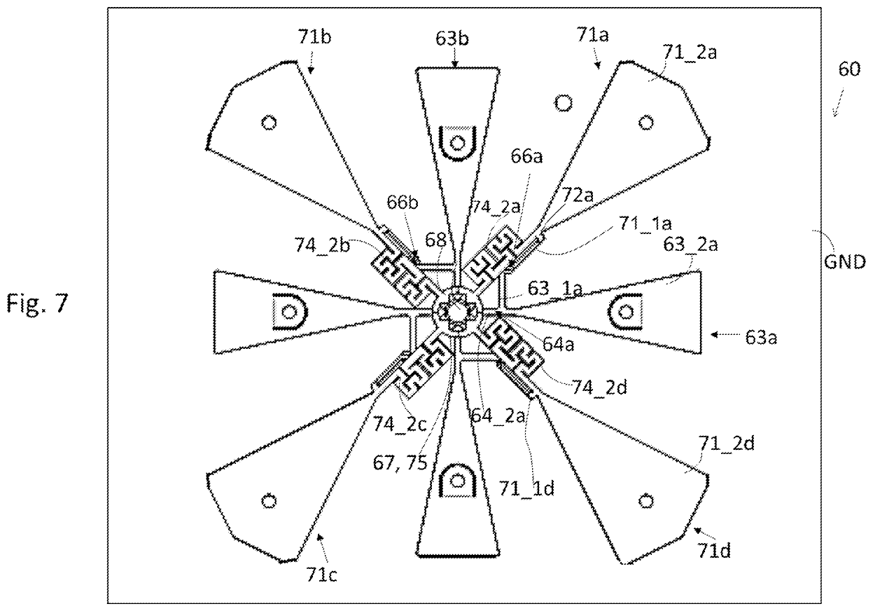

FIG. 6 shows an elevation view of a fourth example of an antenna system 60 having two sets of radiating elements. FIG. 7 shows a plan view of the fourth example of an antenna system 60. As seen the antenna system 60 comprises: a first set 61 of radiating elements configured to operate at least in a first frequency bandwidth, BW1, and a ground plane, GND plane, referred to as GND in the figures. The first set 61 of radiating elements comprises 4 IFA elements; each of the 4 IFA elements comprise a first arm 63 and a second arm 64. Now, with reference to the arm referred to as “a” in the figures, the first arm comprises at least a first section 63_1a extending, at a first extension point 65a, into a second section 63_2a; wherein the first section 63_1a comprises a connection 66a to a corresponding feeding point. Other connections to other feeding points, such as 66b, or other connections not shown, are comprised in the antenna system 60. The scheme is reproduced in the rest of the arms referred to as b, c, d. Each of the 4 IFA elements further comprise a second arm. The IFA element referred to as “a” comprises a second arm 64a, connected to a first GND point 67 which is connected to a common GND connection 68 which is a common GND hollow tube 68. The second arm 64a comprises a first section 68 extending, at the GND point 67, into a second section with reference 64_2a in FIG. 6. The first section 68 forms a common GND connection 68. As seen the antenna system 60 comprises a second set 62 of radiating elements configured to operate at least in a second frequency bandwidth, BW2. The second set 62 comprises second 4 IFA elements. Each of the second 4 IFA elements of the second set comprises a third arm 71a, 71b, 71c, 71d, comprising a first section which, with reference to the third arm 71a in FIGS. 6 and 7, is referred to as 71_1a and extends, at a second extension point 72a, into a second section 71_2a. Each of the second 4 IFA elements comprise a fourth arm 74a, 74b, 74c, 74d, comprising a first section 76 extending, at a second GND point 75, into a second section 74_2a, 74_2b, 74_2c, 74_2d. The first section 76 of all the fourth arms form a shared common GND connection 76. FIG. 7 shows the second sections 64_2 of the second arms and the second section 74_2 of the fourth arms all connected to the GND plane. The second sections (in arm “a” referred to as 64_2a) of the second arms (in arm “a” referred to as 64a) are connected to GND plane through a first common GND connection 68 and the second sections 74_2a, 74_2b, 74_2c, 74_2d of the fourth arms are connected to GND plane through the second common GND connection 76. The length of the first common GND connection 68 defines a first height h1. The length of the second common GND connection 76 defines a second height h2. The common GND connection 76 extends into the first common GND connection 68. Any of the second sections of each first arm may form respective angles βa, βb between 0° and 30°, where 0° and 30° are included, with respect to the plane A. In FIG. 6 the second section 63_2a of the first arm is shown forming an angle βa with the plane A.

The second set of 4 IFA elements are angularly uniformly distributed around the second GND point 75 on a plane B, wherein the plane B is parallel to the GND plane and distanced from the GND plane the second height h2. When viewed from above, as represented in FIG. 7, the first set 61 of radiating elements and the second set 62 of radiating elements, overlap less than a 10% of a uniform angular distribution with respect to each other, in particular, in FIGS. 6 and 7 the first set 61 of radiating elements and the second set 62 of radiating elements IFA elements do not overlap.

The antenna system 60 comprises the PCBA with a first side on which the GND plane is placed, facing the IFA elements. The first side comprises the connection to the feeding points 66a, 66b. The PCBA comprises a second side, opposite to the first side, on which electronic elements 69 are placed, the polarizer, a filter, and an amplifier. The first section 63_1a of the first arm 63a is shown in FIG. 7 as directed towards the first section 71_1a of the third arm 71a. The first section 71_1a of the third arm 71a of the “a” third arm of the second set 62, and the first section 63_1a of the first arm 63a of the first set 61 connection share the connection 66a to a feeding point in the FIGS. 6 and 7. Other connections to feeding points are shared by other arms respectively in the FIGS. 6 and 7 as shown.

The antenna system 60 shown in FIGS. 6 and 7 may act as a multiband antenna system. The multiband antenna system may operate in BW1 from 1559 MHz to 1610 MHz referred to as L1/E1 band. The multiband antenna system may further operate in BW2 from 1164 MHz to 1300 MHz referred to as L5/E5, L2 and Galileo E6, bands. The wavelength λ1 taken for this example may be λ1=ν/1559 MHz, with ν=c, c the speed of light. The wavelength λ2 taken for this example may be λ2=ν/1164 MHz, with ν=c, c the speed of light, 299,792,458 m/s or 3*10⁸ m/s. In other examples the propagation speed may be c/n where n is the refractive index of the propagation medium. When a polarizer is comprised in the antenna system a circular polarization may be performed thereby operating a directive RHCP field at the zenith direction. The antenna system may also provide a configuration for LHCP polarization by minor changes in the configuration of the polarizer circuit.

The antenna system of the disclosure may be mounted in a vehicle. As autonomous driving is becoming a trend in automotive sector, a high demand on multiband and multi-constellation GNSS antennas exists in the market to achieve high-accuracy positioning. The GNSS antenna dimensions should be as small as possible to ensure easy integration of the antenna in a limited available space in the vehicle, preserving good antenna efficiency, gain and good axial ratio. Moreover, in order to meet with GNSS specifications, antennas have to be directive to the zenith with RHCP to maximize the reception and minimize reflections. The antenna system of the disclosure fulfils all the above-mentioned parameters. Other polarization configurations may also be provided.

The antenna system 60 is composed of a combination of two sets of radiating elements which may be referred to as L1 band for the first set of IFA elements and L2/L5 bands for the second set of IFA elements. Each radiating element is composed of four IFA-shaped elements sharing the same common connection to GND 67, 75, resulting as a whole, in two crossed IFA antenna solution. This complete structure is connected to a polarizer circuit, assembled on the PCBA, in for example four points. Then, both crossed IFA elements become connected to each other and then connected to the polarizer circuit on the PCBA. Each IFA element has a bow tie shape in order to increase the operational bandwidth. In addition, the second sections, which with reference to the IFA element “a” is referred to as 74_2a, of the fourth arms, forming the L2/L5 IFA elements, include respective Hilbert elements in order to match the radiating element to the lower frequency bands without increasing the antenna dimensions.

Moreover, the polarizer circuit assembled on the PCB contributes to generating a 90° phase shift between each IFA-shaped element and thus, receiving purely RHCP signal; in this case RHCP signal that is suitable for GNSS. The polarizer can also generate the opposite polarization, i.e., LHCP by minor changes in the configuration of the polarizer circuit, or even changing the polarizer. After the signal has been combined in the polarizer circuit, it is delivered to the next stage composed by a low-noise amplifier, LNA, and a frequency diplexer for proper amplification of the, in this case, GNSS signal and filtering out unwanted ones. The antenna system comprising an amplifier provides an active antenna for signal reception.

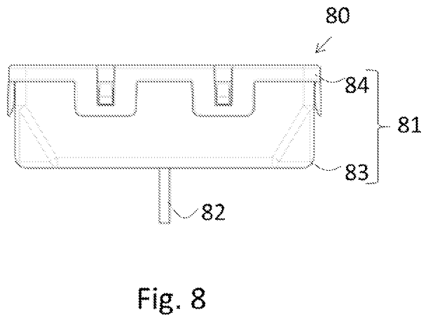

FIG. 8 shows a fifth example of an antenna system 80 comprising a housing 81. The housing comprises a lower housing 83 and a top housing 84, but other configurations may be possible. The antenna system becomes a portable antenna, which can be placed anywhere without the need for third party elements to perform a specific function. The radiating elements and the PCBA are comprised within the housing. The housing may have a compact size, for example for an assembly of radiating elements and the PCBA presenting total dimensions of 80×80×20 mm³, a housing to cover such assembly may present dimensions of 90×90×30 mm3 which may cover the assembly and the PCBA with active elements. FIG. 8 further shows an antenna cable 82 which has been passed through the hollow tube 68 towards the exterior of the antenna system.

The antenna, in this example, may be used for GNSS and may have RHCP radiation pattern, good efficiency and low profile. The antenna system may cover the frequency bands from 1164 MHz to 1300 MHz and from 1559 MHz to 1610 MHz. However, the bandwidth may be adjusted to other frequency bands by modifying the dimensions of any of the lengths of the arms or sections of the arms of the IFA elements.

An example of the proposed solution combines circular polarization RHCP or LHCP, depending on antenna configuration, a combination of different design technics and topologies for antenna size miniaturization. Miniaturization may comprise one or more of the following: firstly, for example, the radiating element widening for example in a bow tie shape, or other shapes or structures, to improve the operational bandwidth; secondly, by meander shaping, comprising for example Hilbert structures, although it might be other shapes or structures, to match the impedance of the radiating element at lower frequencies; thirdly, miniaturization comprises the IFA concept to reduce the effective size of the antenna in both area and height.

An example of the proposed solution further combines relative position of the L1 to L2/L5 elements to reduce coupling or shading between them, a 45 degrees separation between L1 and L2/L5 radiating elements. The first set of radiating elements L1 may be inclined to enhance radiation efficiency and reduce coupling with the second set of radiating elements L2/L5 and with the GND plane. The antenna system provides for a self-grounded solution with the PCBA acting as a director, so the PCBA facing the zenith direction and the radiating elements downwards to ground (nadir). The antenna system provides for an external ground plane solution: If the antenna is installed on top of a large ground plane, the PCBA works as a reflector instead. The antenna system may provide for a central common GND shorting connection for both sets of radiating elements L1-L2/L5 as a metallic tube through which a coaxial cable may be routed in order not to affect the radiation properties of the antenna.

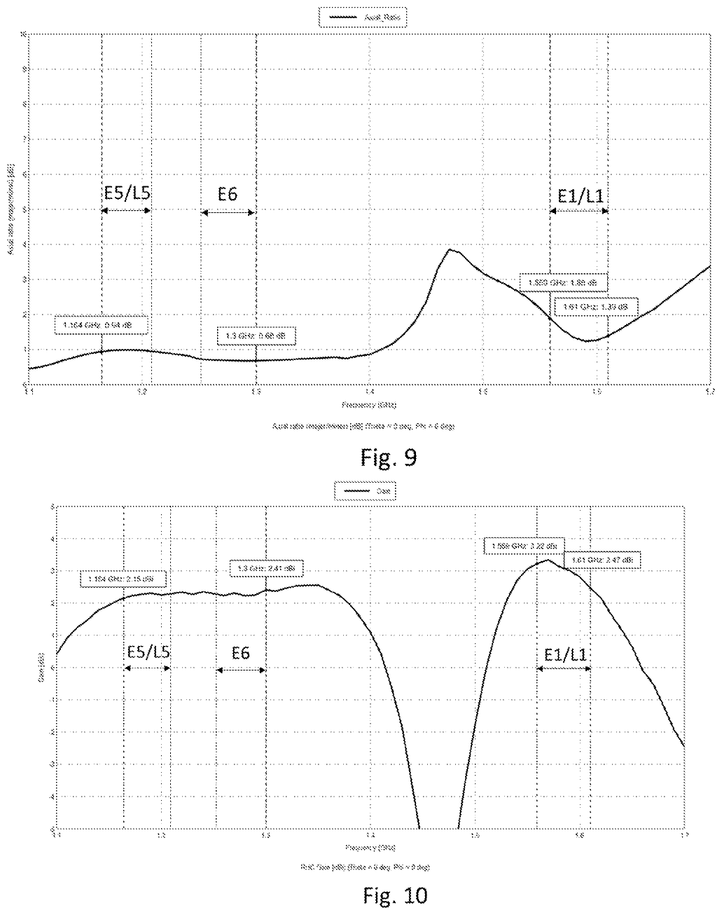

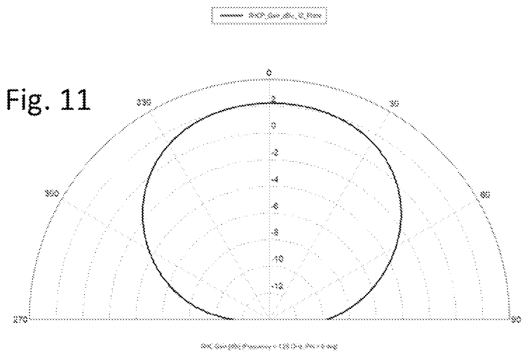

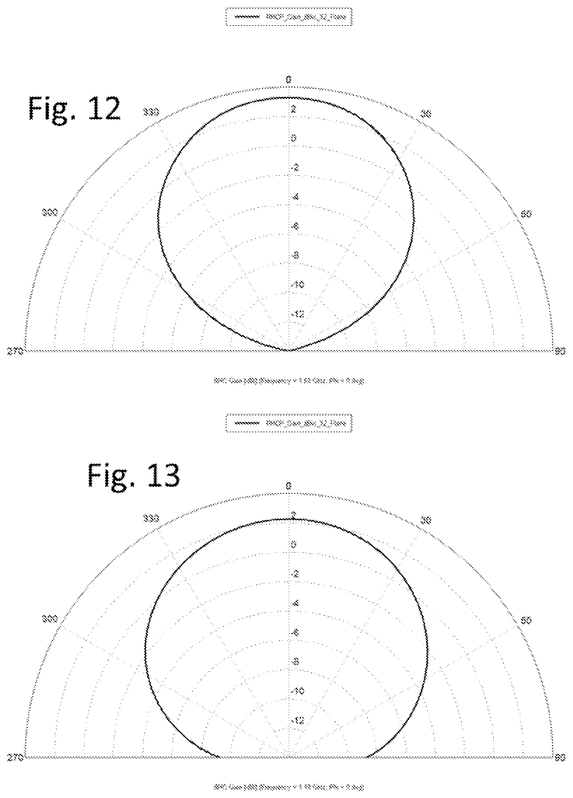

FIG. 9 shows a representation of the antenna axial ratio with respect to frequency. FIG. 9 shows the bands E5/L5, E6 and E1/L1. FIG. 10 shows the RHCP gain at the zenith direction in a director configuration of the antenna system. FIG. 11 shows a vertical cut of the radiation pattern of the antenna system for a frequency of 1.28 GHz, showing the RHCP gain in dB. FIG. 12 shows a vertical cut of the radiation pattern of the antenna system for a frequency of 1.58 GHz, showing the RHCP gain in dB. FIG. 13 shows a vertical cut of the radiation pattern of the antenna system for a frequency of 1.18 GHz, showing the RHCP gain in dB. As seen in the figures, the antenna performance is the highest in the direction of the zenith, but positions outside the zenith do not lose the good performance of the antenna.

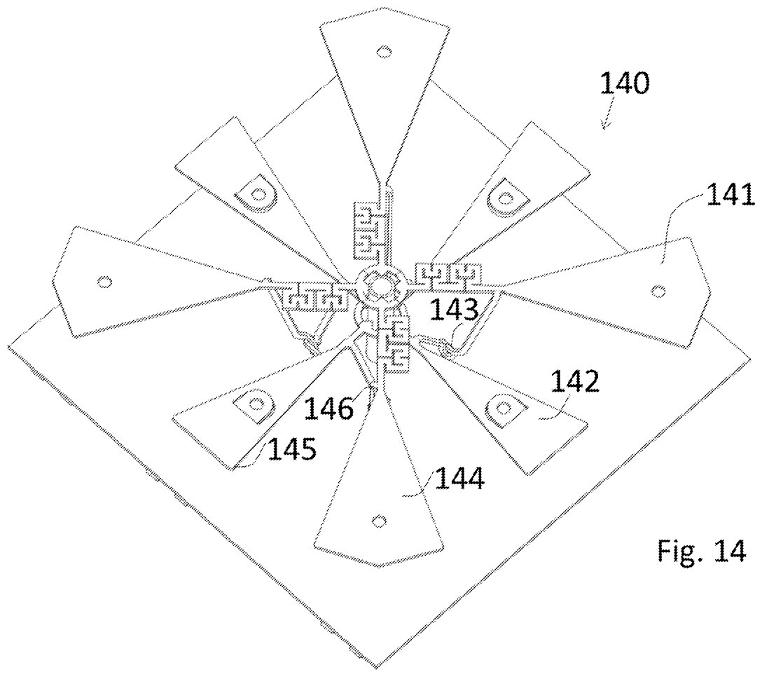

FIG. 14 shows a perspective view of an antenna system 140 according to the disclosure. The FIG. 14 shows an IFA radiating element 141 and an IFA radiating element 142 sharing a connection 143 to a feeding point. The FIG. 14 shows an IFA radiating element 144 and an IFA radiating element 145 sharing a connection 146 to a further feeding point.

The following references are shown in the figures:

### FIGS. 1, 2A and 2B:

10 Antenna system;
11 first set of radiating elements;
12a, 12b, 12c first arms of the first set of IFA radiating elements;
12_1a, 12_1b,12_1c first sections of the first arms;
12_2a, 12_2b, 12_2c second sections of the first arms 12a, 12b, 12c;
13a, 13b, 13c second arms of the first set of IFA radiating elements;
13_2a, 13_2b, 13_2c second sections of the second arms 13a, 13b, 13c;
14a, 14b, 14c connections to feeding points of the first sections;
16a, 16b, 16c first extension points;
17 first GND point;
18 first section of the second arms 13a, 13b, 13c forming a first common GND connection 18;
19a, 19b, 19c first IFA elements;

### FIGS. 3, 4A and 4B:

21 second set of IFA radiating elements;
29a, 29b, 29c second IFA radiating elements;
22a, 22b, 22c third arm of second IFA elements 29a, 29b, 29c;
22_1a, 22_1b, 22_1c first sections of the third arms 22a, 22b, 22c;
23a, 23b, 23c fourth arms of second IFA elements 29a, 29b, 29c;
26a, 26b, 26c second extension points;
22_2a, 22_2b, 22_2c second sections of the third arms 22a, 22b, 22c;
24a, 24b, 24c connections to feeding points;
27 second GND point;
28 first section of the fourth arms 23a, 23b, 23c forming a second common GND connection 28 between the second GND point 27 and the GND plane;
23_2a, 23_2b, 23_2c second section of the fourth arm 23a, 23b, 23c.

### FIG. 5:

50 antenna system
52a, 52b, 52c, 52d first arms;
52_1a, 52_1b, 52_1c, 52_1d first sections of the first arms 52a, 52b, 52c, 52d;
52_2a, 52_2b, 52_2c, 52_2d second section of the first arms;
53a, 53b, 53c, 53d second arms;
53_2a, 53_2b, 53_2c, 53_2d second sections of the second arms 53a, 53b, 53c, 53d;
55a, 55b, 55c, 55d open end of the first arms;
56a, 56b, 56c, 56d extension points;
57 GND point;
58 first section of the second arms forming a shared common GND connection 58;
59a, 59b, 59c, 59d housing positioners.

### FIGS. 6 and 7:

60 antenna system
61 first set of radiating elements;
62 second set of radiating elements;
63a first arm of IFA radiating elements referred to as “a” of the first set 61;
63_1a first section of the first arm 63a;
63_2a second section of the first arm 63a;
63b first arm of IFA radiating elements referred to as “b” of the first set 61;
64a second arm of first set 61 of IFA radiating elements;
64_2a second section of the second arm 64a;
65a first extension point;
66a, 66b connections to feeding points on the first side of the PCBA;
67 first GND point;
68 first section of the second arm 64a forming a common GND connection 68;
71a, 71b, 71c, 71d third arms of the IFA elements of the second set 62;
71_1a, 71_1d first section of the third arms 71a and 71d;
71_2a second section of the third arm 71a;
72a second extension point;
74a, 74b, 74c, 74d fourth arms of the second IFA elements of the second set 62;
76 first section of the fourth arms 74a, 74b, 74c, 74d forming a shared second common GND connection 76;
74_2a, 74_2b, 74_2c, 74_2d second section of the fourth arms 74a, 74b, 74c, 74d;
75 second GND point.

### FIG. 8:

80 antenna system;
81 housing;
82 antenna cable;
83 lower housing;
84 a top housing.

### FIG. 14:

140 antenna system;
141, 142, 144, 145, IFA radiating elements;
143, 146 connections to either feeding point.

What is claimed is:

1. An antenna system comprising:
a first set of radiating elements configured to operate at least in a first frequency bandwidth;
a ground plane, GND plane;
wherein the first set of radiating elements includes a first number N of at least 3 inverted-F radiating elements, first N IFA elements;
wherein each of the first N IFA elements includes:
a first arm including at least a first section extending, at a first extension point, into a second section;
wherein the first section of the first arm includes a connection to a respective feeding point;
a second arm including at least a first section extending, at a first GND point into a second section, the second section of the second arm connected to the first extension point;
wherein the first sections of all the N second arms form a first common GND connection, between the first GND point and the GND plane, wherein a length of the first common GND connection defines a first height and the first GND point is common to the N second sections of the second arms;
wherein the first N IFA elements are distributed around the first GND point on a plane A, wherein the plane A is parallel to the GND plane and distanced from the GND plane the first height, such that the first GND point is positioned in the plane A;
wherein any of the second sections of the first arm or second arms of the first N IFA elements form respective angles between 0° and 30°, where 0° and 30° are included, with respect to the plane A; and
wherein at least one of the second section of the first arms of the IFA elements have an increasing width along the length of the first arms, starting with a first width at at least one of the first extension points and ending in a second width at an open end of the first arms.

2. The antenna system of claim 1, further comprising a printed circuit board assembly, PCBA, wherein the PCBA comprises the GND plane, the feeding points; and
wherein the first N IFA elements or the first and second N IFA elements are placed on or over the PCBA and in connection to the PCBA.

3. The antenna system of claim 2, wherein the PCBA has
a first side on which any of the first or second set of the IFA elements, the GND plane and the connection to the feeding points are placed; and
a second side, opposite to the first side, comprising at least a polarizer.

4. The antenna system of claim 1, wherein a dimension of the GND plane is larger than the largest length of any of the sets of antennas, such that the GND plane encompasses a complete projection of the sets of antennas on the GND plane.

5. The antenna system of claim 1, further comprising a housing, the housing configured to encompass all the sets of radiating elements and the ground plane.

6. The antenna system of claim 5, wherein at least one IFA element comprises fixation elements to fix the at least one IFA element to the housing.

7. The antenna system of claim 1 wherein the first arm has a first length, wherein the first length is the sum of the lengths of at least the first section and the second section, wherein the first length has a value from λ1/8 to λ1/4, being λ1 a wavelength of the lowest frequency in the first frequency bandwidth; and/or
wherein the second arm has a second length wherein the second length has a value from λ1/20 to λ1/2, wherein the second length is the sum of at least the lengths of the first and second sections of the second arm.

8. An antenna system comprising:
a first set of radiating elements configured to operate at least in a first frequency bandwidth;
a ground plane, GND plane;
wherein the first set of radiating elements comprises a first number N of at least 3 inverted-F radiating elements, first N IFA elements;
wherein each of the first N IFA elements comprise:
a first arm comprising at least a first section extending, at a first extension point, into a second section;
wherein the first section of the first arm comprises a connection to a respective feeding point;
a second arm comprising at least a first section extending, at a first GND point, into a second section, the second section of the second arm connected to the first extension point;
wherein the first sections of all the N second arms form a first common GND connection, between the first GND point and the GND plane, wherein a length of the first common GND connection defines a first height and the first GND point is common to the N second sections of the second arms;
wherein the first N IFA elements are distributed around the first GND point on a plane A, wherein the plane A is parallel to the GND plane and distanced from the GND plane the first height, such that the first GND point is comprised in the plane A; and
wherein any of the second sections of the first arm or second arms of the first N IFA elements form respective angles between 0° and 30°, where 0° and 30° are included, with respect to the plane A;
wherein the antenna system further comprises:
a second set of radiating elements configured to operate at least in a second frequency bandwidth;
wherein the second set of radiating elements comprises a second number N of at least 3 inverted-F radiating elements, second N IFA elements;
wherein each of the second set of N IFA elements comprise:
a third arm comprising at least a first section extending, at a second extension point, into a second section;
wherein the first section of the third arm comprises a connection to a corresponding feeding point;
a fourth arm comprising at least a first section extending, at a second GND point, into a second section, the second section of the fourth arm connected to the second extension point;
wherein the first sections of all the N fourth arms form a second common GND connection between the second GND point and the GND plane, wherein a length of the second common GND connection defines a second height and the second GND point is common to the N second sections of the fourth arms;
wherein the second N IFA elements are distributed around the second GND point on a plane B, wherein the plane B is parallel to the GND plane and distanced from the GND plane the second height, such that the second GND point is comprised in the plane B;
wherein any of the second sections of the third arms or of the fourth arms of the second N IFA elements form respective angles between 0° and 30°, where 0° and 30° are included, with respect to the plane B.

9. The antenna system of claim 8 further comprising a printed circuit board assembly, PCBA, wherein the PCBA comprises the GND plane, the feeding points; and
wherein the first N IFA elements or the first and second N IFA elements are placed on or over the PCBA and in connection to the PCBA.

10. The antenna system of claim 9, wherein the PCBA has
a first side on which any of the first or second set of the IFA elements, the GND plane and the connection to the feeding points are placed; and
a second side, opposite to the first side, comprising at least a polarizer.

11. The antenna system of claim 10 further comprising, on the second side, a filter, an amplifier, and a shielding configured to surround at least the filter and the amplifier, providing a direct connection to GND plane, the shielding comprising a metal sheet of electrically conductive material.

12. The antenna system of claim 8 wherein the first and second common GND connections together form one common metallic tube.

13. The antenna system of claim 12 wherein the metallic tube is hollow, and an antenna cable connected to the PCBA is arranged along the inside of the hollow tube.

14. The antenna system of claim 8 wherein a dimension of the GND plane is larger than the largest length of any of the first or second sets of radiating elements, such that the GND plane encompasses a complete projection of the sets of radiating elements on the GND plane.

15. The antenna system of claim 8 wherein the first height has a value from λ/20 to λ/10 and/or wherein the second height has a value from λ/20 to λ/10.

16. The antenna system of claim 8 further comprising a housing, the housing configured to encompass all the sets of radiating elements and the GND plane.

17. The antenna system of claim 16 wherein at least one IFA element comprises fixation elements to fix the at least one IFA element to the housing.

18. The antenna system of claim 8 wherein the first arm has a first length, wherein the first length is the sum of the lengths of at least the first section and the second section, wherein the first length has a value from λ1/8 to λ1/4, being λ1 a wavelength of the lowest frequency in the first frequency bandwidth; and/or
wherein the second arm has a second length wherein the second length has a value from λ1/20 to λ1/2, wherein L2 is the sum of at least the lengths of the first and second sections of the second arm.

19. The antenna system of claim 18 wherein the third arm has a third length, wherein the third length is the sum of at least the lengths of the first section and the second section of the third arm wherein the third length has a value from λ2/8 to λ2/4, being λ2 a wavelength of the lowest frequency in the second frequency bandwidth; and/or
wherein the fourth arm has a fourth length and the fourth length has a value from λ2/20 to λ2/2, wherein the fourth length is at least the sum of the length of the first and second sections of the fourth arm.

20. An antenna system comprising:
a first set of radiating elements configured to operate at least in a first frequency bandwidth;
a ground plane, GND plane;
wherein the first set of radiating elements comprises a first number N of at least 3 inverted-F radiating elements, first N IFA elements;
wherein each of the first N IFA elements comprise:
a first arm comprising at least a first section extending, at a first extension point, into a second section;
wherein the first section of the first arm comprises a connection to a respective feeding point;
a second arm comprising at least a first section extending, at a first GND point, into a second section, the second section of the second arm connected to the first extension point;
wherein the first sections of all the N second arms form a first common GND connection, between the first GND point and the GND plane, wherein a length of the first common GND connection defines a first height and the first GND point is common to the N second sections of the second arms;
wherein the first N IFA elements are distributed around the first GND point on a plane A, wherein the plane A is parallel to the GND plane and distanced from the GND plane the first height, such that the first GND point is comprised in the plane A; and
wherein any of the second sections of the first arm or second arms of the first N IFA elements form respective angles between 0° and 30°, where 0° and 30° are included, with respect to the plane A;
wherein at least one of any of the second sections of the second arm have a meandered shape.
